(19) United States
(12) Patent Application Publication
(10) Pub. No.: US 2024/0149964 A1
(43) Pub. Date: May 9, 2024

(54) WEAR PAD FOR A TREAD MEMBER OF A CRAWLER TRACK OF A TRACK UNIT OF A CONSTRUCTION MACHINE, TREAD MEMBER FOR A CRAWLER TRACK, CRAWLER TRACK FOR A TRACK UNIT OF A CONSTRUCTION MACHINE, CONSTRUCTION MACHINE, AND METHOD FOR TRANSMITTING CONTACT FORCES OF A CONSTRUCTION MACHINE INTO A BASE PLATE OF A TREAD MEMBER

(71) Applicant: BOMAG GMBH, Boppard (DE)

(72) Inventor: Jonathan STAHL, Boppard (DE)

(21) Appl. No.: 18/504,671

(22) Filed: Nov. 8, 2023

(30) Foreign Application Priority Data
Nov. 8, 2022 (DE) 10 2022 211 813.8

(51) Int. Cl. B62D 55/28

(52) U.S. Cl. CPC B62D 55/28

(57) ABSTRACT

A wear pad for a tread member of a crawler track of a track unit of a construction machine, a tread member for a crawler track, a crawler track for a track unit of a construction machine, a construction machine, and a method for transmitting contact forces of a construction machine into a base plate of a tread member.

### FIELD

The invention relates to a wear pad for a tread member of a crawler track of a track unit of a construction machine, a tread member for a crawler track, a crawler track for a track unit of a construction machine, a construction machine, and a method for transmitting contact forces of a construction machine into a base plate of a tread member.

### BACKGROUND

Generic construction machines are in particular road construction machines, for example road milling machines or road pavers as well as feeders. Such construction machines are typically used in road and pathway construction as well as in the construction of public squares or take-off and landing runways. They have a machine frame with a travel mechanism and an operator platform. They are typically driven by a drive motor, which may be, for example, an internal combustion engine, in particular a diesel internal combustion engine, or an electric motor. These are self-propelled construction machines that can be controlled in particular by an operator from the operator platform. In work operation, these construction machines move over the ground in a working direction while working said ground and/or participating in a ground working process.

Road milling machines, especially cold-type milling machines, are used, for example, to mill off old road surfaces. For this purpose, they feature a milling drum mounted for rotation in a milling drum box. The milling drum is a hollow-cylindrical tube with a plurality of milling tools, for example milling chisels arranged on its outer surface. The milling tools are driven into the ground by the rotation of the milling drum thereby milling the ground. Via a conveyor, the milled material is transferred out of the milling drum box and onto a transport vehicle, such as a truck, for removal.

Road pavers are used for laying base layers, for example of asphalt or concrete. They typically have a material hopper at their front from which the paving material is transported through the machine to the rear. There, the paving material is distributed over the entire paving width by a transverse distribution device, such as a screw conveyor. In addition, road pavers comprise a screed at their rear that smoothes and precompacts the paving material.

Typically, road pavers are loaded with paving material by transport vehicles during operation, with the transport vehicles traveling ahead of the road paver and dumping the paving material into the material hopper. Feeders may be used to ensure that the road pavers can operate as continuously as possible. These are also configured as self-propelled machines and are interposed between the transport vehicles delivering the paving material and the road pavers. They have a material hopper into which the transport vehicles dump the paving material. From this material hopper of the feeder, the material is then transferred to the material hopper of the road paver via a conveyor. This enables an exact quantity of required paving material to be delivered to the road paver in a continuous manner, thus bridging situations in which there are currently too many or not enough transport vehicles with paving material available.

Generic construction machines have a travel mechanism with at least one track unit. The track unit, in turn, comprises a crawler track and at least one drive wheel driven by the drive motor and, optionally, further running and/or support wheels. The crawler track, in turn, includes a plurality of tread members, each of which may include, in particular, a wear pad and a base plate. The wear pads are typically replaceable and represent that part of the crawler track with which the latter comes into direct contact with the ground when the generic construction machines are moving. This ground contact causes wear to the wear pads. Once wear has progressed to a certain degree, the wear pads must be replaced, especially before the base plates come into contact with the ground during movement of the generic construction machines and then wear themselves and/or damage the underlying ground. The wear pads are typically made of a wear pad material, such as a plastic. To securely fasten them to the base plates, which are usually made of steel, it is known to embed metallic reinforcing elements in the wear pads and then provide a threaded connection between the reinforcing elements and the base plates. The reinforcing elements embedded in the wear pad then also fasten the wear pads to the base plate. Such a structure of wear pads and tread members can be found, for example, in EP 0 994 013 A1, EP 1 900 621 A2 and EP 2 272 739 A1.

The disadvantage of this previous structure is that contact forces of the generic construction machines can act directly on the reinforcing elements due to the rigid connection of the reinforcing elements to the base plates via the threaded connection. As a result of the repeated loads on the wear pads during travel operation, the contact forces applied to the wear pads in contact with the ground lead to considerable stresses in the wear pads, which may ultimately even cause one or more of the reinforcing elements within the wear pads to break. In this case, the wear pad may no longer be reliably held in position on the crawler track. In this case, the wear pad must be replaced immediately, often especially before the actual wear limit of the wear pad is reached. It is known to make the reinforcing elements solid and with a large plate thickness in order to thereby obtain an increased resistance to the applied contact forces. In addition, the reinforcing elements are often edged and/or provided with bead-like structures, for example to increase their rigidity or to adapt them to the geometry of the base plate and/or the wear pad. As a result, the known reinforcing elements as a whole are often highly three-dimensionally deformed and thus have a complex structure, which regularly incurs comparatively high material and manufacturing costs. Another disadvantage of edged reinforcing elements is that the material of the wear pad can be sheared off at the edges of the reinforcing elements during operation. This also reduces the service life of the wear pads up to their wear limit, which likewise increases operating costs of the construction machines due to the then necessary early replacement of the wear pads.

### SUMMARY

Against this background, it is the object of the present invention to improve wear pads and their use with regard to their service life and ideally at the same time with regard to their manufacturing costs, in order to thereby keep their acquisition costs and thus the operating costs of the generic construction machines as low as possible.

A wear pad according to the invention for a tread member of a crawler track of a track unit of a construction machine first comprises a pad body made of a wear pad material and having a wear side and a fastening side opposite the wear side. The wear side thus refers to the side of the wear pad that comes into direct and immediate contact with the underlying ground when the wear pad is used as intended. The fastening side, on the other hand, refers to the opposite side that rests against the surface of a base plate of a tread member of a crawler track when used as intended.

Part of a wear pad according to the invention further is at least one reinforcing element, which is at least partially enclosed by the wear pad material of the pad body, in particular encapsulated as part of the manufacturing process. The reinforcing element comprises at least two fastening recesses spaced apart in a longitudinal extension direction of the reinforcing element, in particular in the form of through openings. Ideally, the reinforcing element is made of a much harder material than the material of the wear pad. The wear pad material is in particular a plastic, more particularly a polyurethane, whereas the reinforcing element is in particular a metal, especially a steel material. Thus, in particular, it may also be preferred if the material from which the wear pad material is made is considerably more easily elastically and/or plastically deformable than the material used for the reinforcing element. In particular, the wear pad material may have a Shore A hardness in a range from 40 to 98 Shore A, especially from 60 to 95 Shore A, as, for example, determined according to the method specified in DIN ISO 7619-1:2010.

The wear pad according to the invention further comprises two fastening elements which are at least partially enclosed, in particular encapsulated, by the wear pad material of the pad body and are each arranged in a fastening recess on the reinforcing element. It is important to note that the two fastening elements are separate components with respect to the reinforcing element, i.e., the fastening elements are not formed by the reinforcing element itself. Functionally, the two fastening elements first of all represent counterparts of a releasable fastening connection required for mounting the wear pad to a base plate, in particular for engagement for suitable fastening screws coming from the base plate, as will be described in more detail below. For this purpose, the two fastening elements may each comprise a fastening opening which is open to the outside in a direction toward the fastening side and has an internal thread, the internal thread having a thread axis extending transversely and, in particular, perpendicularly to a longitudinal extension direction of the reinforcing element. The internal thread is thus a profiled groove that runs continuously in a helical manner in a hollow-cylindrical opening. The longitudinal extension direction of the reinforcing element designates the axis of the main extension of the preferably longitudinally extended reinforcing element.

Each of the at least two fastening elements further comprises a displacement stop that protrudes in a radial direction of the thread axis relative to the fastening recess of the reinforcing element. The displacement stop thus mechanically prevents the respective fastening element from being pushed completely through the corresponding fastening recess in the reinforcing element. According to the invention, the fastening elements are inserted in the fastening recesses of the reinforcing element such that their respective displacement stop is, at least partially around the fastening recess, in positive contact with a side of the reinforcing element facing the wear side of the pad body. In this way, a unidirectional axial lock is thus formed for the reinforcing element relative to the respective fastening element along the thread axis in a direction toward the wear side of the pad body. Conversely, the fastening element is secured in its displacement position toward the fastening side relative to the reinforcing element by this displacement stop.

However, the displacement stop on the fastening elements is provided to act only in one displacement direction relative to the reinforcing element, at least within a certain range, in particular of at least three millimeters, and is thus preferably configured to act only unidirectionally relative to the reinforcing element. Starting from an advantageous assembly situation, this is the case in particular relative to the reinforcing element in a direction toward the wear side. In order to allow the degree of freedom of movement required for this, the fastening elements have a displacement guide region which adjoins the displacement stop in a direction toward the fastening side and is configured to pass through the fastening recess in a direction toward the fastening side, the displacement guide region comprising an extension region which adjoins the part surrounded by the fastening recess directly in a direction toward the fastening side and does not protrude beyond the fastening recess in a radial direction. In a direction toward the fastening side, the extension region extends along the thread axis preferably by at least three millimeters. The extension region is thus configured such that the reinforcing element itself can be displaced relative to the fastening elements in the direction of the thread axis, at least along this extension region, starting from an initial position in which the respective fastening element rests with the displacement stop on the side of the reinforcing element facing the wear side, in the direction of the fastening side. This aspect is important below in that, even though the elements in question are held in position relative to each other by the wear pad material in an unloaded condition, movement of the reinforcing element relative to the fastening elements along the thread axis becomes possible when the wear pad is loaded by the weight of the machine, thereby reducing bending forces applied to the reinforcing element under load, as will be discussed in further detail below.

Further, part of the fastening elements is in each case a mounting contact surface arranged opposite the displacement stop in an axial direction of the thread axis, wherein the mounting contact surface of the fastening elements is preferably in each case planar, especially in each case in a contact plane and more preferably in a common contact plane perpendicular to the thread axis. The mounting contact surface thus refers to a mounting contact surface of the fastening elements, which is provided for direct positive contact of the fastening elements with a base plate when mounted for use. For this purpose, according to the invention, the wear pad material enclosing and adjoining the fastening elements does not protrude beyond the contact surface in a direction toward the fastening side. In other words, the mounting contact surface of the fastening elements forms part of the outer surface of the wear pad. Further, the mounting contact surface is at least flush with the adjacent outer surface formed by the wear pad material or protrudes beyond it in the direction of the thread axis toward the fastening side.

Part of the wear pad is also a positive rotation lock cooperating with the reinforcing element in both directions of rotation about the thread axis of the two fastening elements, which in particular prevents the fastening elements from rotating about the thread axis in the reinforcing element at least when they rest with their respective displacement stop against the side of the reinforcing element facing the wear side or are positioned within the extension region in the reinforcing element. For this purpose, according to the invention, the respective stop elements, which are in positive contact with each other in a direction of rotation about the thread axis, are formed by the reinforcing element and the respective fastening element. In other words, according to the invention, the fastening elements are prevented from rotating within the respective fastening recess due to a positive engagement, in particular a positive engagement established directly between the respective fastening element and the reinforcing element. In this way, fastening screws coming from the base plate can be screwed into the fastening elements reliably and with sufficient torque when mounting the wear pad.

Finally, in the wear pad according to the invention, the reinforcing element is held in position relative to the fastening elements in a displacement direction toward the fastening side exclusively by the wear pad material, in particular at least when the reinforcing element abuts against the displacement stop in the direction toward the wear side. Thus, in particular, no welded connection is provided between the fastening elements and the reinforcing element. In addition, the reinforcing element may be completely covered by wear pad material toward the fastening side, thus ensuring that no part of the reinforcing element is in direct contact with a base plate toward the fastening side in the assembled state.

Preferably, the reinforcing element extends exclusively in a straight-lined manner in the longitudinal direction. This means that the reinforcing element ideally runs along a straight line in a longitudinal extension direction and, for example, has no three-dimensional deformations along this direction, for example in the form of bent and angled portions.

The reinforcing element may have a base body configured as a round, oval or flattened tube or as a square tube or as a U-profile, in each case in particular having a straight-lined longitudinal extension. These structures have the advantage that they are particularly stable against forces applied transversely to the longitudinal extension direction.

Ideally, one of and in particular the fastening elements are configured as a collar nut. These are in particular nuts with a polygonal cross-section, in particular hexagonal nuts, with an internal thread, which include a disc forming the displacement stop on one end face of the nut and protruding beyond the polygonal cross-section in a radial direction of the internal thread. The end face of the nut opposite this end face, which preferably has a polygonal, in particular hexagonal, contour, is ideally planar and forms, in particular completely, the mounting contact surface. It is particularly preferred if the outer surface of the respective fastening element, which has polygonal cross-section, extends continuously from the disc to the mounting contact area with a same or constant cross-sectional contour in a plane perpendicular to the thread axis.

The outer circumference of the displacement guide region of at least one of the fastening elements, in particular of all the fastening elements, is ideally polygonal, in which case the fastening recess of the reinforcing element, in which the displacement guide region is arranged, is preferably of complementary polygonal shape. The rotation lock acting between the respective fastening elements and the reinforcing element is then formed by a direct and immediate positive engagement between these polygonal parts.

The specific configuration of the body of the wear pad or pad body may also vary. It has proved advantageous if the pad body comprises at least one pad body ridge on its fastening side. A pad body ridge comprises a bulge arranged opposite a main body adjacent thereto. The pad body ridge preferably protrudes vertically up to a ridge height from a base body of the pad body, which is in particular of essentially parallelepipedal configuration, and extends at least partially in a longitudinal extension direction of the reinforcing element. In practice, the shape of the base body is not exactly parallelepipedal, inter alia due to the manufacturing process, but may in particular have chamfered or rounded edges, in particular toward the wear side. Importantly for this preferred embodiment, the reinforcing member is arranged within the pad body ridge and is at least partially enclosed by the material of the pad body ridge. For this particular embodiment of the invention, it is preferred if the fastening element extends into the wear pad no further than up to this ridge height. With respect to the direction toward the wear side, the reinforcing element is thus ideally located completely in a pad body ridge and thus not in the base body. This ensures a comparatively long service life of the wear pad, since first the base body can essentially wear out before the reinforcing element arranged in the pad body ridge is exposed to such an extent that it comes into direct contact with the ground on the wear side during operation.

The wear pad, in particular the pad body and/or the pad body ridge, are preferably made of a plastic, in particular polyurethane.

The fastening recesses in the reinforcing element are preferably established in the reinforcing element by thermal cutting, in particular by laser cutting.

Another aspect of the invention relates to a tread member for a crawler track of a track unit of a construction machine. The tread member comprises a base plate with a plate body and at least two webs arranged on the plate body, the webs protruding from the plate body, extending at least partially parallel to one another in a longitudinal extension direction and forming a fastening channel which runs or is arranged between the plate body and the webs. The webs and the plate body thus form a groove-like support structure to accommodate a wear pad. The tread member according to the invention therefore further comprises a wear pad according to the invention, as described above. This wear pad is at least partially arranged or supported in the fastening channel, in particular with the pad body ridge and the reinforcing element. The fastening elements are ideally configured for fastening the wear pad to the base plate, in particular directly, with screws coming from the base plate preferably engaging in the fastening elements.

It is advantageous if the plate body of the base plate has a fastening means passage, wherein a tightening element coming from the side of the plate body facing away from the wear pad can be screwed through the fastening means passage and into the internal thread. The tightening element may in particular be configured as a threaded bolt or screw that can be screwed into the internal thread of a respective one of the fastening elements.

It is ideal if the fastening elements, in particular with their respective mounting contact surface, are in direct contact with the plate body of the base plate via a respective planar mating contact surface. This makes it possible to tighten the fastening elements directly and immediately to the mating contact surface, thus counteracting subsequent settlement. In particular, it is preferred if there is no wear pad material between the respective mounting contact surface and the base plate.

In contrast, it is preferred if material of the wear pad, in particular material of the pad body ridge, is arranged between the reinforcing element and the base plate, in particular completely with the exception of the fastening elements. In this way, when a load is applied from the wear side, for example when a construction machine is standing on the wear pad, the reinforcing element is held exclusively by the wear pad material in a direction toward the base plate and can thus follow a compression of the wear pad material to a certain extent decoupled from the respective fastening elements particularly well without forces being transmitted from the reinforcing element to the fastening elements.

Although the specific shape can be varied in many ways, it has proved advantageous if a total of three webs are provided on the plate body, forming two fastening channels, with a pad body ridge and a reinforcing element being arranged in each of the fastening channels. In this way, particularly reliable mounting of the wear pad with a high load capacity can be achieved.

Another aspect of the invention relates to a crawler track for a track unit of a construction machine, the crawler track comprising at least one wear pad according to the invention and/or a tread member according to the invention.

Moreover, the invention also relates to a construction machine, in particular a road milling machine, with a track unit, the construction machine comprising at least one crawler track according to the invention, a wear pad according to the invention and/or a tread member according to the invention.

Finally, the invention also relates to a method for transmitting contact forces of a construction machine into a base plate of a tread member. A construction machine according to the invention, in particular a road milling machine, a crawler track according to the invention, a wear pad according to the invention and/or a tread member according to the invention are particularly suitable for carrying out the method according to the invention.

The method according to the invention comprises supporting the reinforcing element in the wear pad of the tread member. In particular, it is advantageous if the reinforcing element is supported in the wear pad such that it is held in position in a direction toward the base plate or toward the fastening side exclusively by the wear pad material and thus does not slip onto the base plate solely due to wear pad material present between the reinforcing element and the base plate.

If contact forces from a construction machine are now introduced into the wear pad of this construction machine, material of the wear pad is compressed between the reinforcing element and the base plate of the tread member. A proportional weight of the construction machine resting against the base plate presses in the direction of the underlying ground and thus also on the wear pad material lying between the reinforcing element and the base plate of the tread member. This can lead to elastic and/or plastic deformations in the wear pad material, especially with increasing operating hours of the respective wear pad, in particular due to the pulsating weight force load on the wear pad during travel operation, because with each revolution of a crawler track, the construction machine alternately stands on the wear pad on the one hand and, on the other hand, the wear pad is subsequently free from ground contact and thus a weight force load by the construction machine.

According to the invention, simultaneously with the compression of the wear pad toward the base plate, a displacement of the reinforcing element along at least two fastening elements, which are stationary with respect to a base plate of the tread member, takes place and vice versa. The reinforcing element can thus follow the compression and/or decompression movement of the wear pad material to at least a limited extent, whereby resulting bending forces acting on the reinforcing element are significantly reduced.

It is then possible, in particular, for contact forces to be transmitted to the base plate via material of the wear pad that is in direct contact with the base plate, whereas the reinforcing element is and remains free of contact with the base plate. Furthermore, due to the direct contact of the fastening elements with the base plate, a stable tightening means connection, in particular a screw connection, which is decoupled from at least a large part of the pulsating weight force load, is possible, which is in particular essentially free of settlement and thus particularly low-maintenance.

### BRIEF DESCRIPTION OF THE DRAWINGS

The invention will be explained in more detail below by reference to the embodiment examples indicated in the figures. In the schematic figures:

FIG. 1 is a side view of a construction machine, in this case a road milling machine;

FIG. 2 is an oblique perspective view of a reinforcing element;

FIG. 3 is an oblique perspective exploded view of the reinforcing element of FIG. 2 with fastening means;

FIG. 4 is an oblique perspective view of the reinforcing element of FIG. 2 with inserted fastening means;

FIG. 5 is an oblique perspective exploded view of a wear pad and base plate;

FIG. 6 is a cross-sectional view of the wear pad inserted in the base plate according to FIG. 5, transverse to the longitudinal extension of the reinforcing element;

FIG. 7 is a cross-sectional view of the wear pad inserted into the base plate and fastened by tightening means as shown in FIG. 6, transverse to the longitudinal extension of the reinforcing element;

FIG. 8 is a cross-sectional view in the direction of the longitudinal extension of the reinforcing element of the wear pad inserted in the base plate and fastened by tension means as shown in FIG. 7, with the reinforcing element in a cross-section;

FIG. 9 is an oblique perspective view of a fastening element; and

FIG. 10 is a flow chart of a method according to the invention.

### DETAILED DESCRIPTION

Like components or functionally like components are designated by like reference numerals in the figures. Components that are repeated in the figures are not completely indicated separately in each individual figure.

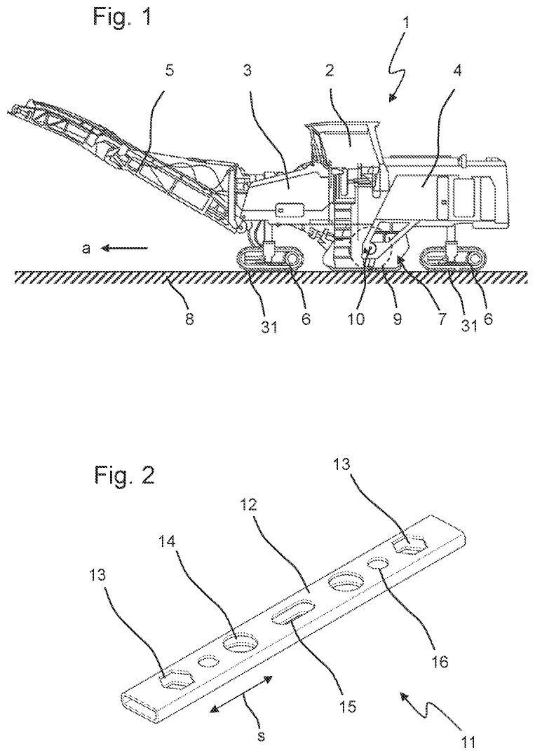

FIG. 1 shows a side view of a construction machine 1. The construction machine 1 may comprise an operator platform 2, a machine frame 3, a drive motor 4, and/or a conveyor 5. The construction machine 1 may be a road milling machine. Ideally, the construction machine 1 is configured as a self-propelled construction machine 1. The drive power required for travel and work operation may be generated by the drive motor 4. As a working device, the construction machine 1 may have a milling drum box 7 with a milling drum 9 mounted in its interior for rotation about a rotation axis 10 extending in particular horizontal and transverse to the working direction. In work operation, the milling drum engages the ground 8 and mills it to a desired milling depth. Construction machines 1, especially road milling machines, are usually used for road resurfacing.

The machine frame 3 may be supported by travel units configured as track units 6. These track units 6 may be connected to the machine frame 3 via lifting columns in order to be able to adjust the machine frame in height relative to the ground, for example. The track units 6 may be in the form of a crawler track 31, which may comprise a plurality of wear pads 22. In travel operation, for example, the construction machine moves in a working direction a over the underlying ground 8. This basic structure is per se known in the prior art. An essential aspect of the invention now is the structure of the wear pad 22, which will be described in more detail below. The wear pads 22 are of particular importance in practical use in that they are alternately loaded and unloaded by the weight of the rest of the construction machine 1 as the crawler track 31 rolls on the underlying ground 8 during travel operation and can wear in direct contact with the ground. This not only relates to abrasive wear on the ground-contacting surface of the wear pads 22, but may also relate to bending wear that can cause fractures in the wear pad 22 or in individual components of the wear pad 22. The structure described below counteracts this “internal” wear of the wear pads 22.

For this purpose, first of all, at least one reinforcing element 11 is provided in the wear pad 22, which is shown per se in an oblique perspective view showing a possible embodiment example in FIG. 2. The reinforcing element 11 may accordingly have a base body 12, fastening recesses 13 and recesses 12 to 16. The base body 12 may be, for example, a flat tubular member having a flat cylindrical or, at least essentially, rectangular shape. The reinforcing element 11 has a longitudinal extension direction s. This direction designates in particular the direction of the reinforcing element 11 having the greatest extension, in particular linear extension, of the reinforcing element 11. Perpendicularly thereto, the reinforcing element comprises a height and a width, wherein the reinforcing element may correspond to at least double and in particular at least triple the height with respect to its width, irrespective of further details in the embodiment example. Instead of the at least partially completely circumferential cross-sectional profile of the reinforcing element 11 in a sectional plane perpendicular to the longitudinal extension s, it is also possible to configure the reinforcing element as a U-shaped rail, V-shaped rail or the like. The reinforcing element comprises at least two fastening recesses 13 spaced apart from one another in the longitudinal extension direction s, the function of which will be described in more detail below. The fastening recesses may be configured such that they pass completely through the reinforcing element 11. In other words, this means that the fastening recesses 13 each represent a through opening through the reinforcing element 11 extending along a linear axis. The fastening recesses are provided to receive fastening elements, as described in further detail below. For this purpose, it is ideal if the fastening recesses 13 have a polygonal contour which, when fastening elements are inserted, together with them form a rotation lock. In addition to the fastening recesses 13, the reinforcing element 11 can have further cutouts which, for example, may also be formed as through openings (for example 14 and 15) or which extend only partially through the reinforcing element (for example 16). These openings may serve to embed, in particular encapsulate, the reinforcing element more optimally in a wear pad material and to counteract the formation of cavities. All of the recesses 13 to 16 may be established in the reinforcing element 11 or a prestage of the reinforcing element 11, for example, by thermal cutting, in particular laser cutting.

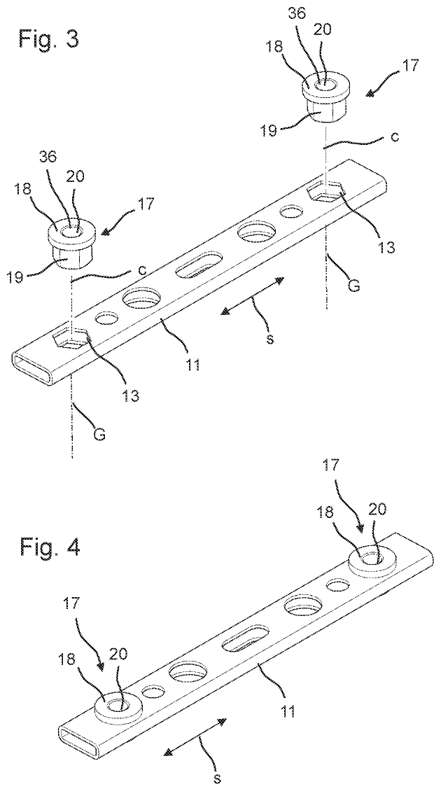

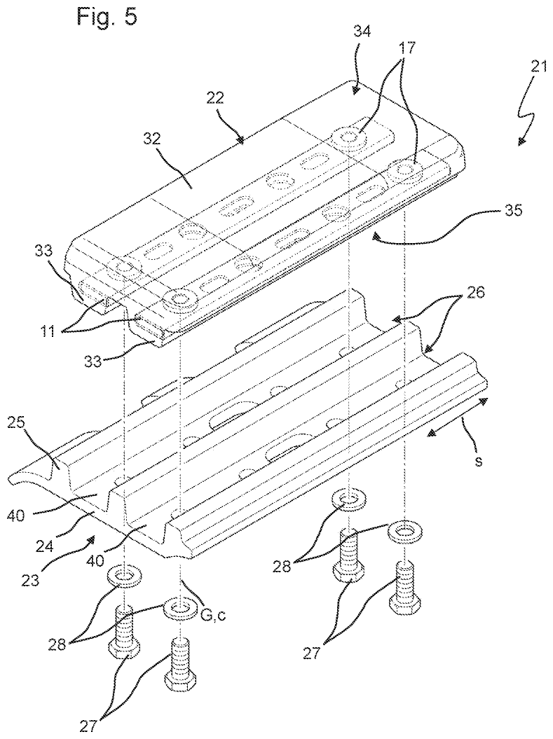

FIG. 3 shows two fastening elements 17 which can be inserted into the fastening recesses 13 along the linear axes c transverse to the longitudinal extension direction s of the reinforcing element 11 up to the abutment position shown in FIG. 4. The axes c may be perpendicular to the outer surface of the wear side of the wear pad, as illustrated, for example, in FIGS. 5 to 8. The fastening elements 17 may be configured as so-called collar nuts, as shown by way of example in FIG. 3 et seqq. Part of the fastening elements 17 further is a respective internal thread 20, the thread axis G of which may run in particular coaxially to the axis c. The internal thread 20 is ideally configured such that a threaded opening is provided in the fastening means at least toward the fastening side of the wear pad (explained below). The threaded hole may thus be configured as a blind hole or also as a through opening. The fastening means may comprise a displacement guide region 19 which is essentially complementary to the fastening recesses 13 with respect to the outer surface and extends longitudinally in a direction of the axes c, for example with a polygonal, in particular hexagonal, cross-sectional contour. In this way, the fastening elements 17 can be partially inserted through the fastening recesses 13 in the reinforcing element 11 coming from a wear side of the wear pad. To prevent the fastening elements 17 from sliding completely through the reinforcing element 11, they comprise a displacement stop 18. An essential feature of this displacement stop 18 is that it protrudes in a radial direction relative to the axis c (and later also G) beyond the outer surface of the displacement guide region and can thus abut against the edge region of the reinforcing element surrounding the fastening recesses 11. The displacement stop may be configured as an annular disc adjoining the polygonal outer surface region of the displacement stop 18 in the direction of the axis c and protruding at least partially radially beyond it. The configuration of the displacement guide region 19, which is essentially complementary to the contour of the fastening recesses 13, means that the fastening elements 17 can be displaced linearly along the displacement guide region along the axis c (and G) from the stop position shown in FIG. 4, in which the displacement stop 18 rests against the reinforcing element 11, in a direction away from the reinforcing element 11 toward the wear side. At the same time, rotation of the fastening elements 17 in the respective fastening recesses 13 of the reinforcing element 11 is prevented, since the complementary polygonal configuration prevents rotation of the two elements 11 and 17 about the axis c (and G) via positive engagement. On the end face opposite the displacement stop 18, the fastening means further have a planar mounting contact surface 30, not shown in FIGS. 3 and 4, toward a fastening side of the wear pad. For further clarification, FIG. 9 shows an enlarged and alternative view of a fastening element 17 in the form of a collar nut.

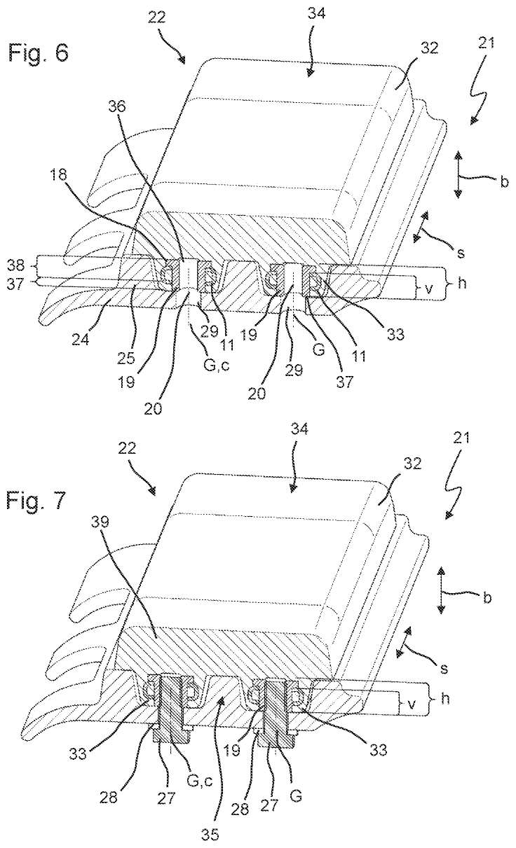

FIG. 5 shows a wear pad 22 for mounting a tread member 21 of a track unit. In this particular embodiment example, the wear pad 22 comprises two reinforcing elements 11 with inserted fastening elements 17, the reinforcing elements 11 extending parallel to each other in the wear pad. Both reinforcing elements 11 with their fastening elements 17 may be completely embedded in wear pad material, in particular plastic wear pad material, except for the mounting contact surface 30. Thus, the outer surface of the wear pads 22 may be formed solely by the wear pad material, particularly the plastic wear pad material, and by mounting contact surfaces 30 of the fastening elements 17 surrounding the fastening openings 36 (FIG. 6). The wear pad 21 comprises a wear side 34 and a fastening side 35. On the wear side 34, the wear pad can come into contact with the underlying ground 8 during travel operation of a construction machine 1 if installed and used as intended, and may thus be subject to wear. On the fastening side 35, on the other hand, the wear pad is mounted to a usually metallic base plate 23 as a support structure. The wear side may be formed by a pad body 32. This pad body may be in the form of a parallelepiped, in particular with edges rounded or chamfered toward the wear side 34. This pad body 32 preferably comprises only the wear pad material, particularly the plastic wear pad material. One or more pad body ridges 33 may adjoin the pad body 32 toward the fastening side 35, the ridges preferably formed essentially by a same material as the pad body 32. The ridges may have a ridge height h in a direction toward the base plate 23 or parallel to the axis c/G, with which they protrude from the pad body 24. The pad body ridges 33 may extend in a web-like manner on the fastening side in a longitudinal extension direction. In particular, the reinforcing elements 11 may each be located in or enclosed by one of the pad body ridges 33. It is advantageous if the reinforcing elements 11 are located completely in a respective one of the pad body ridges 33, in particular also within the ridge height h. For engagement with such a wear pad 21, the base plate 23 comprises, for example, a plate body 24 and, on the side facing the wear pad 21, a plurality of longitudinally extending webs 25 parallel to one another, which may form one or more fastening channels 26. The wear pad may engage with its pad body ridges 33 in the fastening channels 26, so that in this way a defined relative position between the wear pad 21 and the base plate 22 can be achieved more easily for mounting purposes. The actual fastening of the wear pad 21 to the base plate 22 is carried out with the aid of tightening elements 27, in particular fastening screws, which, coming from the base plate 22, can be screwed into the internal threads 20 of the fastening elements 17 via corresponding external threads having thread axes G. Part of this threaded connection may further be washers 28. Fastening means passages 29 may be provided in the base plate for this purpose, which passages may be formed from the side of the base plate 23 facing the wear pad to the side facing away from the wear pad 22.

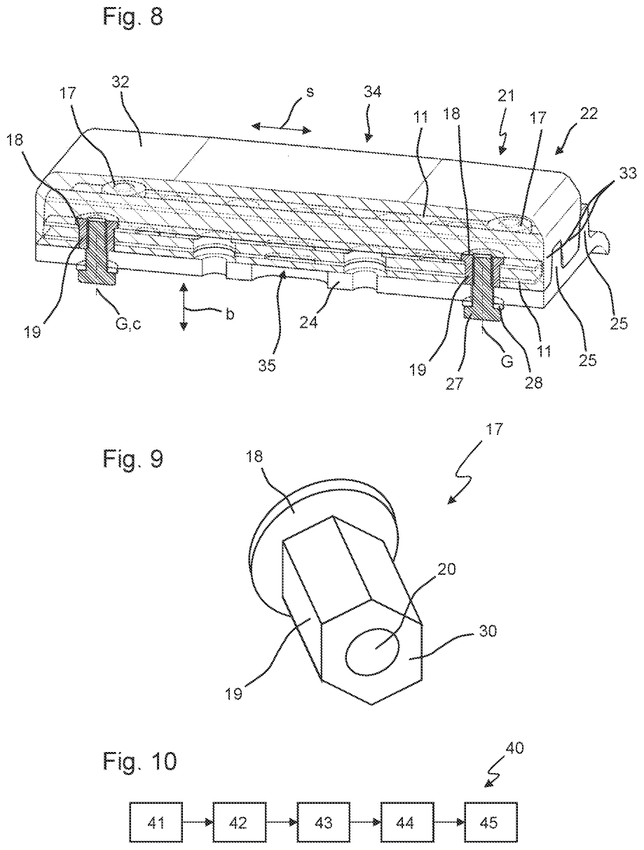

FIG. 5 is a cross-sectional view transverse to the longitudinal extension direction s of the reinforcing elements 11. In FIG. 6, the wear pad 22 is placed on a base plate 23. The fastening means passages 29 and the fastening openings 36 are positioned so as to overlap each other so that tightening elements 27 coming from the base plate 23 can engage through the fastening means passages 29 and the fastening openings 36 and into the internal thread regions of the fastening means 17 and can be tightened. In this case, the tightening elements 27 abut directly or indirectly, for example via the washers 28, against the outer side of the base plate 23 facing away from the wear pad 22 with stops protruding radially with respect to the axes c/G, as illustrated in FIG. 7. If the tightening means are now tightened, the fastening elements 17 are tightened on the side of the base plate 23 facing the wear pad 22 and rest with their planar mounting contact surfaces 30 directly on the base plate in positive contact on corresponding mating contact surfaces 40, which in this region is ideally complementary to the mounting contact surfaces 30. It is thus possible to decouple the tightening force generated by the threaded connection between 17 and 27 practically completely from the reinforcing element 11. FIG. 8 illustrates the fastening situation shown in FIG. 7 in a longitudinal cross-sectional view along the longitudinal extension s of a reinforcing element 11.

It is now essential that the fastening elements 17 have a displacement guide region 19 which, when the respective fastening element 17 is inserted in the reinforcing element in such a way that it rests with its linear stop on the reinforcing element 11, has along the axis c/G a part surrounded by the fastening recess 13, or a part 38 which is inserted in the thickness of the reinforcing element 11, and an extension region 37 which protrudes beyond the reinforcing element in the direction of the axis c/G toward the side of the wear pad 22 facing the fastening side on the base plate 23, in which extension region the fastening means element 17 does not protrude beyond the respective fastening recess 13 in a radial direction relative to the axis c/G. For this purpose, the fastening element 17 may extend with constant cross-sectional contour in a plane perpendicular to the axis c/G up to the mounting contact surface 30. At the same time, the fastening element 17 may be held in the reinforcing element exclusively by the wear pad material, in particular plastic wear pad material, in particular polyurethane, surrounding the fastening element 17 and the reinforcing element 11. During travel operation of the construction machine, the tread member 21 is subjected to pressure on the wear side 34 by the weight of the construction machine when the construction machine rests on the tread member 21. This load is eliminated when the corresponding tread member 21 is lifted off the ground during travel operation of the construction machine. Therefore, an alternating pressure load occurs in the direction of arrow b. This alternating pressure load in the direction of arrow b can trigger mechanical movements in the wear pad 22, for example due to elastic and/or plastic deformations in the wear pad material. These can also affect the reinforcing element 11. However, due to the fact that the reinforcing element 11 is not bonded to the fastening elements 17, which in turn are in block contact with the base plate 23, the reinforcing element 11 can follow these mechanical movements along c/G decoupled from the fastening elements 17. In this way, bending loads on the reinforcing element 11 in particular, which could otherwise increase, can be reduced. The displacement region comprises an extension v in a direction of the axis c/G and is ideally located within the ridge height h.

The extension region 37 preferably has an extension in the direction of the axis c/G which corresponds to at least 10%, preferably at least 30%, of the extension of the region 38 in a direction of the axis c/G. Additionally or alternatively, the extension region 37 preferably has an extension in a direction of the axis c/G which corresponds to at most twice, preferably at most once, the extension of the region 38 in a direction of the axis c/G.

It is further optimal if in a direction of the axis c/G between the material of the reinforcing element 11 and the fastening side 35 there is exclusively wear pad material, particularly preferably of constant thickness.

FIG. 10 finally illustrates steps of a method according to the invention. The wear pad 22 described above is particularly suitable for carrying out this method for transmitting contact forces of a construction machine into a base plate of a tread member. The method comprises supporting 41 the reinforcing element 11 in the wear pad 22 of the tread member 21, introducing 42 contact forces of a construction machine via the wear pad 22, compressing 43 material of the wear pad 22 between the reinforcing element 11 and a base plate 23 of the tread member 21, displacing 44 the reinforcing element 11 simultaneously with compressing 43 the wear pad 22 toward the base plate 23 along at least two fastening elements 17 that are stationary relative to a base plate 23 of the tread member 21, and transmitting 45 contact forces into the base plate 23 via material of the wear pad 22 directly contacting the base plate.

What is claimed is:

1. A wear pad for a tread member of a crawler track of a track unit of a construction machine, comprising:
a pad body of a wear pad material having a wear side and a fastening side opposite the wear side;
a reinforcing element at least partially enclosed by the wear pad material of the pad body, the reinforcing element having two fastening recesses spaced apart in a longitudinal direction of the reinforcing member; and
two fastening elements which are at least partially enclosed by the wear pad material of the pad body and which are each arranged in a fastening recess on the reinforcing element, each of the two fastening elements comprising:
a fastening opening which is open to the outside in a direction toward the fastening side and has an internal thread, the internal thread having a thread axis extending transversely and, in particular, perpendicularly to the longitudinal extension direction of the reinforcing element;
a displacement stop which protrudes in a radial direction of the thread axis relative to the fastening recess in the reinforcing element, which, at least partially around the fastening recess, is in positive contact with a side of the reinforcing element facing the wear side of the pad body and forms a unidirection axial lock for the reinforcing element relative to the respective fastening element along the thread axis in a direction toward the wear side of the pad body;
a displacement guide region which adjoins the displacement stop in a direction toward the fastening side and is configured to pass through the fastening recess in a direction toward the fastening side, the displacement guide region comprising an extension region which adjoins the part surrounded by the fastening recess directly in a direction toward the fastening side and does not protrude beyond the fastening recess in a radial direction;
a mounting contact surface opposite the displacement stop in an axial direction of the thread axis, the mounting contact surface being planar in a contact plane perpendicular to the thread axis, the wear pad material surrounding the fastening elements and adjoining them in each case not protruding beyond the contact plane in a direction toward the fastening side, wherein:
in each case a positive rotation lock cooperating with the reinforcing element in both directions of rotation about the thread axis of the two fastening elements is provided, wherein the respective stop elements resting against one another in a positive manner in the direction of rotation about the thread axis are formed by the reinforcing element and the respective fastening element; and
the reinforcing element is held in position relative to the fastening elements in a displacement direction toward the fastening side exclusively by the wear pad material, in particular at least when the reinforcing element abuts against the displacement stop in the direction toward the wear side.

2. The wear pad according to claim 1, wherein the reinforcing element extends exclusively in a straight-lined manner in the longitudinal extension direction.

3. The wear pad according to claim 1, wherein the reinforcing element has a base body configured as a round, oval or flattened tube or as a square tube or as a U-shaped profile.

4. The wear pad according to claim 1, wherein at least one fastening element is configured as a collar nut.

5. The wear pad according to claim 1, wherein the mounting contact surface of the fastening element is planar.

6. The wear pad according to claim 1, wherein the outer circumference of the displacement guide region of at least one fastening element is of polygonal configuration and the fastening recess of the reinforcing element, in which the displacement guide region is arranged, is of complementary polygonal configuration, and in that the rotation lock is formed by positive engagement between these polygonal parts.

7. The wear pad according to claim 1, wherein the pad body comprises at least one pad body ridge on its fastening side, wherein the pad body ridge protrudes perpendicularly from a base body of the pad body up to a ridge height, the base body being formed in particular essentially prism-like (square side faces; trapezoidal etc.), and extends at least partially in the longitudinal extension direction of the reinforcing element, the reinforcing element being arranged in the pad body ridge and being at least partially enclosed by the material of the pad body ridge, and the fastening element extending into the wear pad by no more than up to this ridge height.

8. The wear pad according to claim 1, wherein the wear pad, in particular the pad body and/or the pad body ridge, is made of polyurethane.

9. The wear pad according to claim 1, wherein the fastening recesses are established in the reinforcing element by thermal cutting, in particular laser cutting.

10. A tread member for a crawler track of a track unit of a construction machine, comprising:
a base plate having a plate body and at least two webs arranged on the plate body, the webs protruding from the plate body, extending at least partially parallel to one another in the longitudinal extension direction and forming a fastening channel arranged between the plate body and the webs;
a wear pad according to claim 1, which is arranged at least partially, in particular with the pad body ridge and the reinforcing element, in the fastening channel;
wherein the fastening elements are configured for fastening the wear pad to the base plate.

11. The tread member according to claim 10, wherein the plate body of the base plate has a fastening means passage, wherein a tightening element can be screwed into the internal thread through the fastening means passage coming from the side of the plate body facing away from the wear pad.

12. The tread member according to claim 11, wherein the tightening element is configured as a threaded bolt or screw which can be screwed into the internal thread.

13. The tread member according to claim 10, wherein the fastening elements, in particular with the respective mounting contact surface, directly contact the plate body of the base plate via a respective planar mating contact surface.

14. The tread member according to claim 10, wherein material of the wear pad, in particular material of the pad body ridge, is arranged between the reinforcing element and the base plate.

15. The tread member according to claim 10, wherein a total of three webs are provided on the plate body, forming two fastening channels, each of the fastening channels having a pad body ridge and a reinforcing element arranged therein.

16. A crawler track for a track unit of a construction machine, wherein the crawler track comprises at least one wear pad or at least one tread member according to claim 10.

17. A construction machine, in particular a road milling machine, with a track unit, wherein the track unit comprises at least one wear pad or at least one tread member or a crawler track according to claim 16.

18. A method for transmitting contact forces of a construction machine into a base plate of a tread member according to claim 10, comprising the steps of:
a) supporting the reinforcing element in the wear pad of the tread member;
b) introducing contact forces of a construction machine via the wear pad;
c) compressing material of the wear pad between the reinforcing member and a base plate of the tread member;
d) displacing the reinforcing element simultaneously with compressing the wear pad in a direction toward the base plate along at least two fastening elements which are stationary with respect to a base plate of the tread member;
e) transmitting contact forces into the base plate via material of the wear pad directly contacting the base plate.
